(19) United States
(12) Patent Application Publication
(10) Pub. No.: US 2012/0062510 A1
(43) Pub. Date: Mar. 15, 2012

(54) CAPACITANCE TOUCH SCREEN WITH MESH ELECTRODES

(76) Inventors: Michael Mo, Shenzhen (CN); Hua Li, Shenzhen (CN); JK Zhang, Shenzhen (CN)

(21) Appl. No.: 13/226,902

(22) Filed: Sep. 7, 2011

(30) Foreign Application Priority Data
Sep. 10, 2010 (CN) CN201010289860.3

(51) Int. Cl. G06F 3/044

(52) U.S. Cl. 345/174

(57) ABSTRACT

A capacitance touch screen with mesh electrodes includes a first electrode group and a second electrode group made of transparent conductive material. Particularly, at least either the first electrode or the second electrode includes at least two sub-electrode plates, all the sub-electrode plates in the electrodes which are the same are arranged in accordance with a mesh structure. The capacitance distribution of the prior art is changed from concentrated capacitance to decentralized distributed capacitance through the mesh electrodes, to ensure the touch screen to have higher effective capacitivity even in suspended state, the waterproof performance of the touch screen is increased, and the properties including ESD resistance, aging resistance, etc. of the capacitance touch screen are enhanced.

The present application claims priority of Chinese patent application Serial No. 201010289860.3, filed Sep. 10, 2010, the content of which is hereby incorporated by reference by entirely.

### TECHNICAL FIELD

The present invention relates a device for converting screen touch information to electrical signals reflecting touch position or intensity, particularly to a device for converting touch information to electrical signals reflecting touch position by using the capacitor as a medium.

### BACKGROUND

In accordance with various realization principles, the touch screens of the prior art include resistance touch screens, capacitance touch screens, infrared surface touch screens and the like, wherein the capacitance touch screens become popular because of the advantages of high light transmittance, resistance to abrasion, resistance to ambient temperature change, resistance to ambient humidity change, long service life and good capability of realizing high and complex functions such as multipoint touch.

The capacitance change is used as the sensing principle for a long time. In order to make the touch screen work effectively, a transparent capacitance sensor array is required. When a human body gets close to or touches the electrode of the capacitor, the capacitance detected by the control circuit can be changed, and the touch situation of the human body can be judged in accordance with the distribution values of capacitance change on the screen. In accordance with the capacitance formation mode, the touch screen includes self-capacitance touch screen and mutual capacitance touch screen, wherein the self-capacitance touch screen uses the change of the capacitance formed by the electrodes and an AC level electrode to reflect the touch position; and the mutual-capacitance touch screen uses the change of the capacitance formed by two electrodes to reflect the touch position. The prior art uses the effective capacitivity to measure the performance of the capacitance touch screen. The effective capacitivity refers to the ratio of the maximum capacitance change because the touch screen is touched to the capacitance when the touch screen is not touched. At present, the body structure of the capacitance touch screen is abundant, which includes rhombic electrode and rectangle electrode in general. But for the screen body, the ordinate of the touch position of the capacitance touch screen is basically detected by laterally arranged electrodes, and the abscissa of the touch position is detected by the vertically arranged electrodes no matter what pattern is. Take the mutual-capacitance touch screen of the prior art as example, the electric field formed between electrodes is shown in FIG. 20, it is known from the distribution principle of electric field lines, when there is potential difference between the two electrodes 100′ and 200′, the surface electric field intensity of the place where the distance between the surfaces of the two electrodes 100′ and 200′ is the shortest is the maximum, and the electric field lines are denser. With the surface distance between the two electrodes 100′ and 200′ is increased and the electric field intensity is reduced, the electric field lines will be accordingly sparse more and more, and both the length and the radian of electric field lines will be increased. Accordingly, a part of electric field lines will penetrate the electrode protecting film 900′ through the driving electrode 100′, and then will return to the sensing electrode 200′. We call the extremely dense power lines within the electrode protecting film 900′ short-range power lines, and call the formed capacitance short-range capacitance; we call the power lines penetrating out the electrode protecting film and then penetrating in the film long-range power lines, and call the formed capacitance long-range capacitance. As mentioned above, the distribution of the original electric field lines will be changed when a human body or a special-purpose touch device 800′ touches the touch screen. A shown in FIG. 21, when a human body or a special-purpose touch device 800′ touches the touch screen, the original part of weak-intensity electric field lines, i.e. long-range power lines, which penetrate the electrode protecting film 900′ to the air through the driving electrode 100′, penetrate the electrode protecting film 900′ again, and return to the sensing electrode 200′ are absorbed by the human body or the special-purpose touch device 800′ and then conducted to the ground; partial short-range power lines are also absorbed by the touch device 800′, and the coupling to the sensing electrode 200′ is reduced. Therefore, the electric field lines returning to the sensing electrode 200′ from the driving electrode 100′ will be reduced, and the capacitance between the driving electrode 100′ and the sensing electrode 200′ will be reduced, so that the changed capacitance C_{T} can be easily detected by the data processing module.

However, both the pattern of the driving electrode and the pattern of the sensing electrode of the capacitance touch screen of the prior art are formed by the single graph, there is short-range capacitance as well as long-range capacitance between the electrodes. Because the absolute breadth of the electrodes is large, while the electrode protecting film 900′ is thin, the long-range capacitance takes large proportion of the total capacitance. When the touch screen is in the suspended state or a suspended conductor covers on the surface of the touch screen, it is equivalent to that there is a small equivalent ground capacitance C_{X} between the human body or the special-purpose touch device 800′ and the ground. As shown in FIG. 22, it seems that the human body or the special-purpose touch device 800′ is suspended in the air. Compared with the condition shown in FIG. 15, when in suspended state, the electric field lines transmitted by the driving electrode 100′ will vertically penetrate the human body or the special-purpose touch device 800′, then only a small part will conducted onto the ground through the equivalent capacitance C_{X}, while the large part will return to the sensing electrode 200′ through the human body or the special-purpose touch device 800′. With the touch area of the human body or the special-purpose touch device 800′ becomes large more and more, the electric field lines transmitted by the driving electrode 100′ will be continuously increased, while the capacity of the electric field lines conducted by the equivalent capacitance C_{X} is not changed, causing the part of electric field lines vertically entering the human body or the special-purpose touch device 800′ to return to the sensing electrode 200′. Because the human body or the special-purpose touch device 800′ exists, the length of the long-range power lines is shortened, and the length of the short-range power lines is increased. The length of the long-range power lines is shortened causes the capacitance to be increased; the length of the short-range power lines is increased causes the capacitance to be reduced. The effect of the change of the long-range power lines is opposite to that of the change of the short-range power lines, and the two effects cancel out each other. If there are more long-range power lines, and the long-range capacitance takes large proportion of the total capacitance, it is possible that the capacitance is not reduced and is increased instead generally. Therefore, the phenomena that the capacitance between the driving electrode 100′ and the sensing electrode 200′ is not reduced when the touch screen is touched by the human body or the special-purpose touch device 800′ in the suspended state, instead, the capacitance between the driving electrode 100′ and the sensing electrode 200′ is increased, so that the touch screen has insensitive response or does not have response will be caused. Because the water in the natural world is not pure water, and water can conduct electricity in general condition, when there is water on the surface of the touch screen, it is equivalent to that there is a suspended conductor on the surface of the capacitance touch screen, so that the condition that there is water on the surface of the touch screen is one of the actual conditions making the touch screen be in suspended state. Then, the influence of the above suspended state on the touch screen can reflect that the waterproof performance of the capacitance touch screen of the prior art is poor.

In addition, the capacitance touch screen of the prior art solves the insulation problem between the driving electrode and the sensing electrode through the bridge cross-over technology of the conductive material under the most condition. If condition that the bridge resistance is too large is caused over-large bridge cross-over resistance of the conductive material or over-narrow breadth of the cross-over bridge, when Electrostatic Discharge (ESD) occurs, it is easy to cause the cross-over bridge to be fused because of over-large current, so that the screen body is damaged.

### Contents of Invention

The present invention provides a capacitance touch screen with mesh electrodes and aims overcome the disadvantages of the prior art through improving electrode structure, reducing long-range capacitance, increasing short-range capacitance, making the formed capacitance be dispersed and uniform, improving the performance of the touch screen in the suspended state, increasing the waterproof performance, improving the linearity of the touch screen; and increasing the connection channels among electrodes, reducing connection resistance among electrodes, and enhancing the properties including ESD resistance, aging resistance, etc. of the capacitance touch screen.

The invention adopts the following technical solution to solve the technical problems: A capacitance touch screen with mesh electrodes is designed and manufactured, and the touch screen includes a first electrode group and a second electrode group made of transparent conductive material, and a data processing module, wherein the first electrode group includes mutually parallel first electrodes, and the second electrode group includes mutually parallel second electrodes; any first electrode and any second electrode are orthogonally arranged in a mutual non-contact mode; and the data processing module is used for sending excitation signals, detecting capacitance change and determining touch position coordinates in accordance with the detecting condition of the capacitance, and both the first electrode group and the second electrode group are electrically connected with the data processing module. Particularly, at least either the first electrode or the second electrode includes at least two sub-electrode plates, all the sub-electrode plates in the electrodes which are the same are arranged in accordance with a mesh structure, namely at least either the first electrode or the second electrode is processed with a mesh, all meshes are surrounded by respective sub-electrode plates around the meshes.

The shape of the sub-electrode plates includes at least one of different polygon, rotundity and ellipse. The polygon includes quadrangle, regular quadrangle, pentagon, regular pentagon, hexagon, regular hexagon, octagon and regular octagon.

In order to further increase the effective capacitivity, on the whole touch screen, the positions of the meshes of the first electrodes are corresponding to the positions of the sub-electrode plates of the second electrodes, the positions of the sub-electrode plates of the first electrodes are corresponding to the positions of the meshes of the second electrodes, namely the positions of the meshes and the sub-electrode plates of the first electrodes are respectively complementary to the positions of the sub-electrode plates and meshes of the second electrodes.

The touch screen is a mutual-capacitance touch screen, the electrode receiving excitation signals from the data processing module in the first electrodes and the second electrodes is a driving electrode, and the electrode used for feeding back electrical signals to the data processing module to detect the capacitance change is a sensing electrode.

The electrodes can use the layered structure, and the first electrodes and the second electrodes are respectively arranged in two mutually parallel planes between which a clearance exists.

The electrodes can also use peer layer bridge cross-over structure, and the first electrodes and the second electrodes are arranged in the same plane.

In order to further increase the effective capacitivity of the touch screen, the touch screen also includes dummy electrodes which are made of transparent conductive material and are in the suspended state. The dummy electrodes are not electrically connected and the dummy electrodes are not electrically connected with other modules of the touch screen. The dummy electrodes and the first electrodes or the second electrodes are arranged in the same plane, or the dummy electrodes are arranged parallel to the first electrodes or the second electrodes.

In order to further increase the effective capacitivity of the touch screen, the touch screen also includes a guard electrode made of transparent conductive material. The guard electrode is electrically connected with the DC power source or is directly connected with the ground. The guard electrode and the first electrodes or the second electrodes are arranged in the same plane, or the guard electrode is arranged parallel to the first electrodes or the second electrodes.

The transparent conductive material includes Indium Tin Oxide (called ITO for short) and Antimony Tin Oxide (called ATO for short).

Compare with the prior art, the capacitance touch screen with mesh electrodes of the invention have the following advantages:

The capacitance distribution of the prior art is changed through the mesh electrodes, the short-range capacitance is increased, the long-range capacitance is reduced to ensure the touch screen to have higher effective capacitivity even in suspended state, the waterproof performance of the touch screen is increased, the linearity is improved, and the properties including ESD resistance, aging resistance, etc. of the capacitance touch screen are enhanced.

### DESCRIPTION OF FIGURES

FIG. 1 is the electrical schematic diagram of the first embodiment of the capacitance touch screen with mesh electrodes of the present invention;

FIG. 2 is a plane diagram of the first electrode 110 of the first embodiment;

FIG. 3 is a plane diagram of the second electrode 210 of the first embodiment;

FIG. 4 is the partial enlarged schematic diagram of the part indicated in A in FIG. 1.

FIG. 5 is the schematic diagram of electric field distribution of the first embodiment;

FIG. 6 is the schematic diagram of the electric field distribution of the first embodiment touched by a human body or a special-purpose touch device 800;

FIG. 7 is the schematic diagram of the electric field distribution of the first embodiment which is in suspended state and is touched by a human body or a special-purpose touch device 800;

FIG. 8 is the electrical schematic diagram of the second embodiment of the present invention;

FIG. 9 is a plane diagram of the first electrode 110 of the second embodiment;

FIG. 10 is the plane diagram of the second electrode 210 of the second embodiment;

FIG. 11 is the electrical schematic diagram of the third embodiment of the present invention;

FIG. 12 is the plane diagram of the first electrode 110 of the third embodiment;

FIG. 13 is the plane diagram of the second electrode 210 of the third embodiment;

FIG. 14 is the electrical schematic diagram of the fourth embodiment of the present invention;

FIG. 15 is the plane diagram of the first electrode 110 of the fourth embodiment;

FIG. 16 is the plane diagram of the second electrode 210 of the fourth embodiment;

FIG. 17 is the electrical schematic diagram of the fifth embodiment of the present invention;

FIG. 18 is the plane diagram of the first electrode 110 of the fifth embodiment;

FIG. 19 is the plane diagram of the second electrode 210 of the fifth embodiment;

FIG. 20 is the schematic diagram of electric field distribution of the capacitance touch screen in the prior art;

FIG. 21 is the schematic diagram of electric field distribution of the capacitance touch screen during touch in the prior art;

FIG. 22 is the schematic diagram of electric field distribution of the capacitance touch screen which is in the suspended state and is touched by a human body or a special-purpose touch device 800′ in the prior art;

### SPECIFIC MODE FOR CARRYING OUT THE INVENTION

The invention is further described hereinafter with reference to embodiments shown in the following figures.

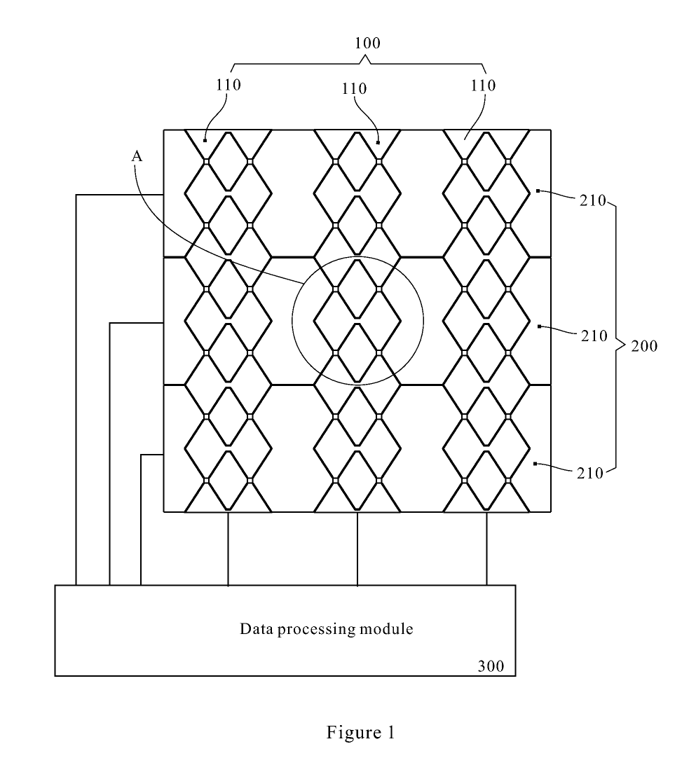

The present invention provides a capacitance touch screen with mesh electrodes, as shown in FIGS. 1, 8, 11, 14 and 17, which includes a first electrode group 100 and a second electrode group 200 made of transparent conductive material, and a data processing module 300, wherein the first electrode group 100 includes mutually parallel first electrodes 110, and the second electrode group 200 includes mutually parallel second electrodes 210; any first electrode 110 and any second electrode 210 are orthogonally arranged in a mutual non-contact mode; the transparent conductive material includes Indium Tin Oxide (called ITO for short) and Antimony Tin Oxide (called ATO for short); and the data processing module 300 is used for sending excitation signals, detecting capacitance change and determining touch position coordinates in accordance with the detecting condition of the capacitance, and both the first electrode group 100 and the second electrode group 200 are electrically connected with the data processing module 300. Particularly, at least either the first electrode 110 or the second electrode 210 includes at least two sub-electrode plates 111 and 211, all the sub-electrode plates 111 and 211 in the same electrodes 110 and 210 are arranged in accordance with a mesh structure; in other words, at least either the first electrode 110 or the second electrode 210 is processed with a mesh 112 and a mesh 212, and each mesh 112 and each mesh 212 are surrounded by respective sub-electrode plates 111 and 211 around the meshes.

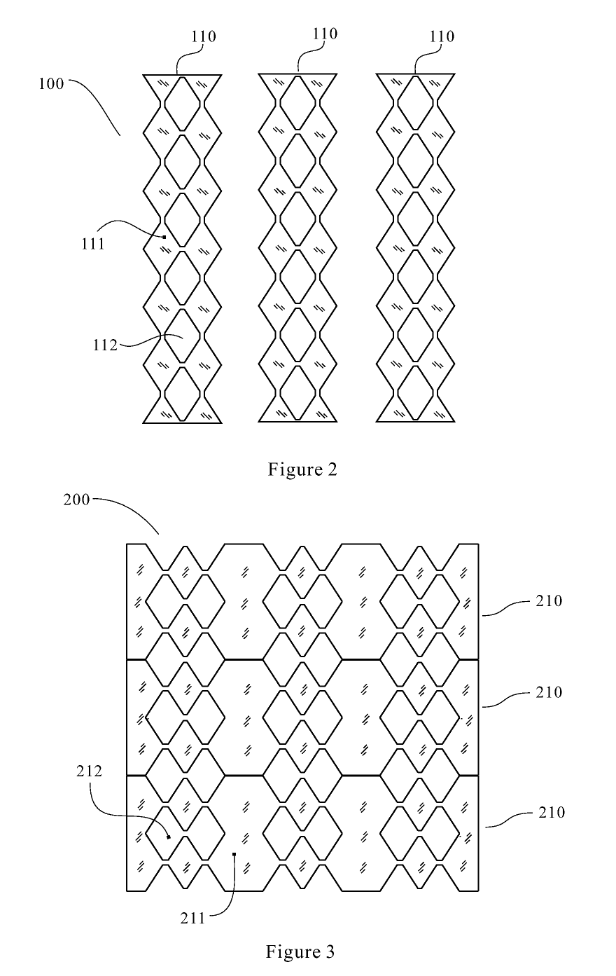

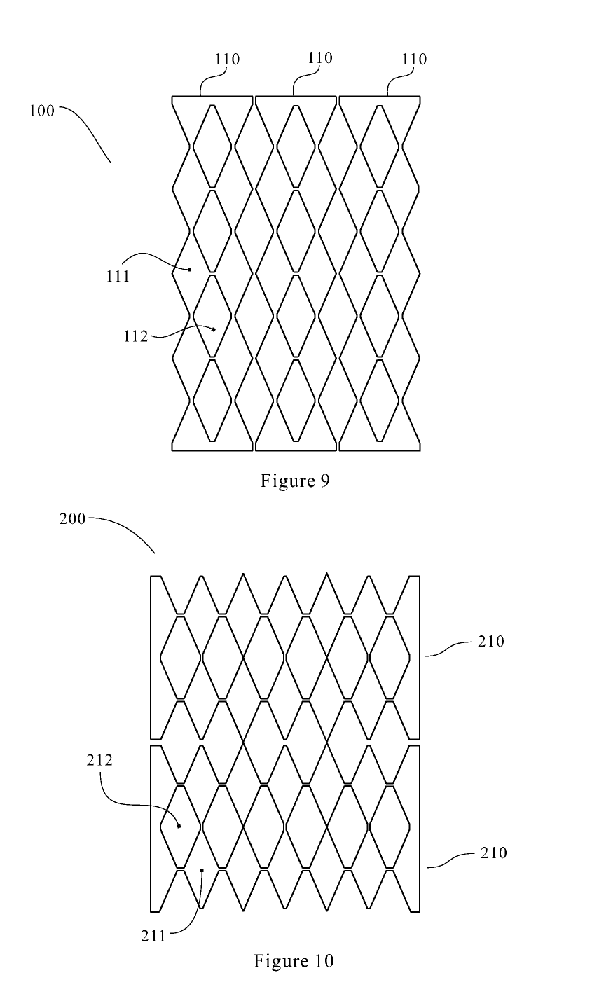

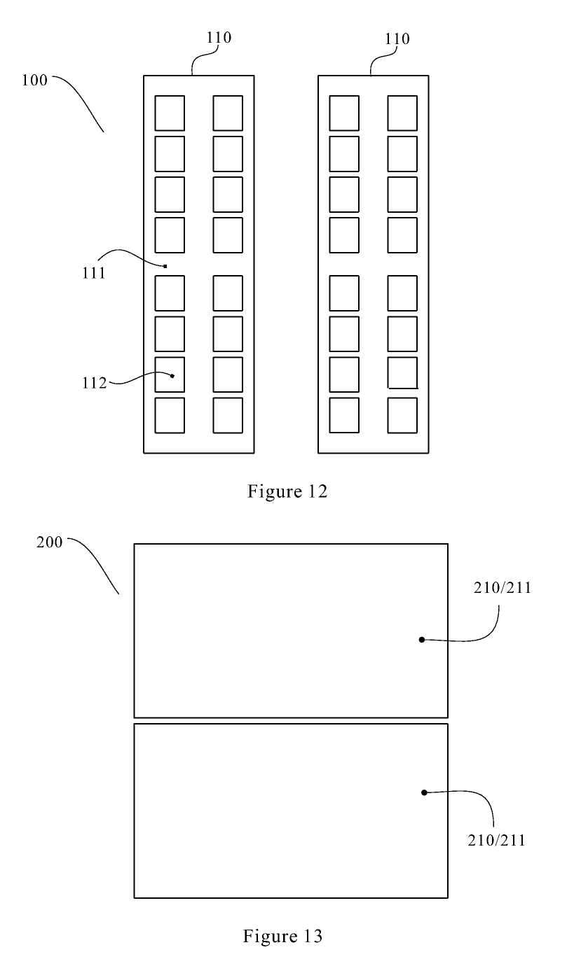

As shown in FIGS. 2, 3, 9 and 10, both the first electrodes 100 and the second electrodes 200 of the first embodiment and the second embodiment of the present invention use the mesh structure. As shown in FIGS. 12 and 13, in the third embodiment of the present invention, the first electrode 100 uses the mesh structure, while the second electrode 200 is an ordinary plate electrode. Therefore, the effect of higher effective capacitivity can be obtained in the suspended state so long as either the first electrode 100 or the second electrode 200 uses the mesh structure.

The present invention improves the touch screen whose capacitance is centrally distributed of the prior art into a touch screen whose capacitance is dispersedly distributed, improves the capacitance between two electrodes of the prior art into multiple small capacitance Cn formed between two electrodes, namely it is equivalent to changing the original capacitance C into the total of multiple small capacitance Cn. For the mutual capacitance touch screen, the driving electrodes of the whole screen body are designed into mesh driving electrodes formed by multiple fundamental graphics units, and the sensing electrodes can be accordingly designed into sensing electrodes formed by fundamental graphs. The so-called mesh structure, namely either the sensing electrode 210 or the driving electrode 110 on the screen body is formed by multiple simple fundamental graphs through crisscross and pairwise connection, and the pattern of the whole screen body is similar to a mesh.

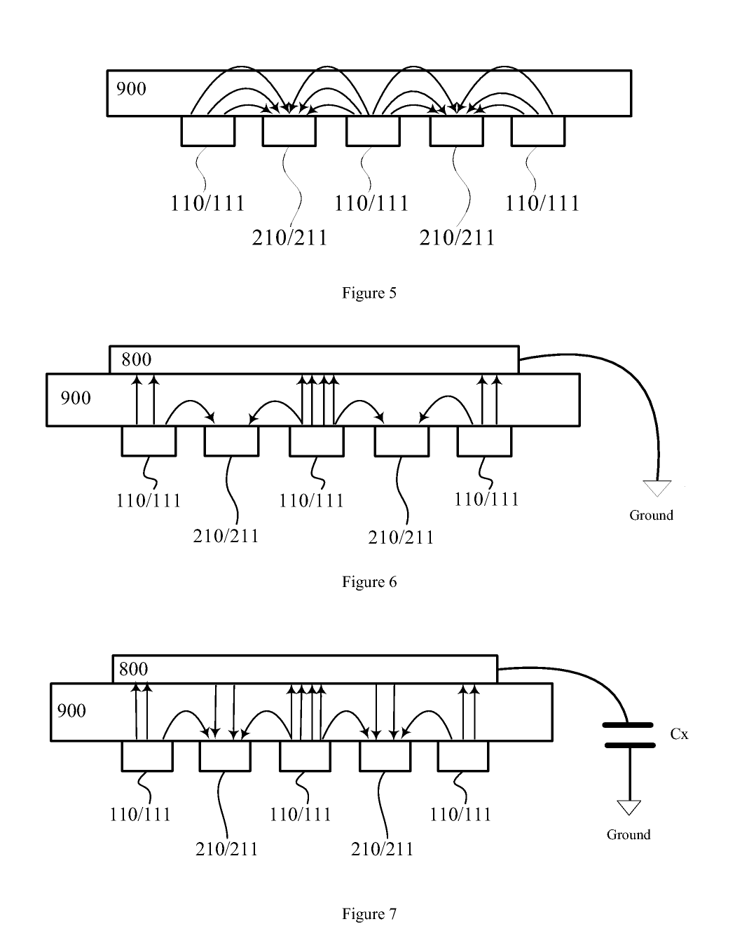

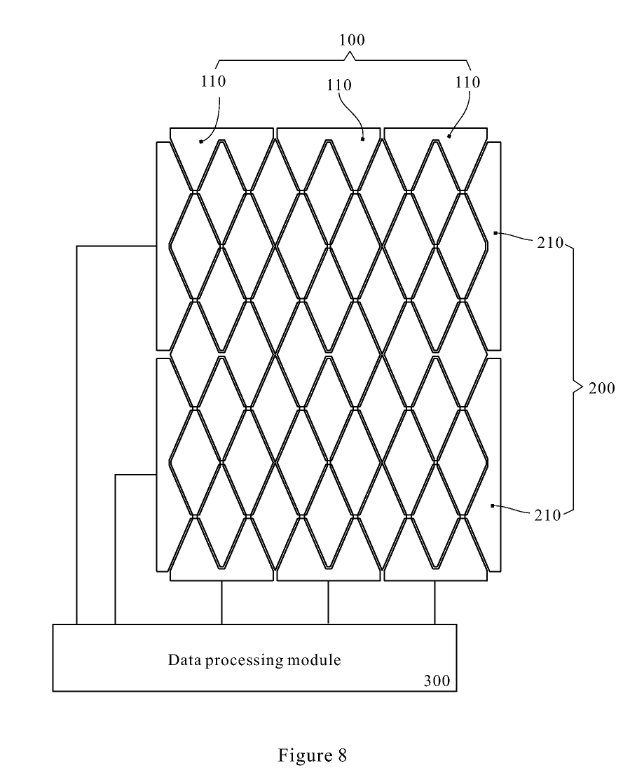

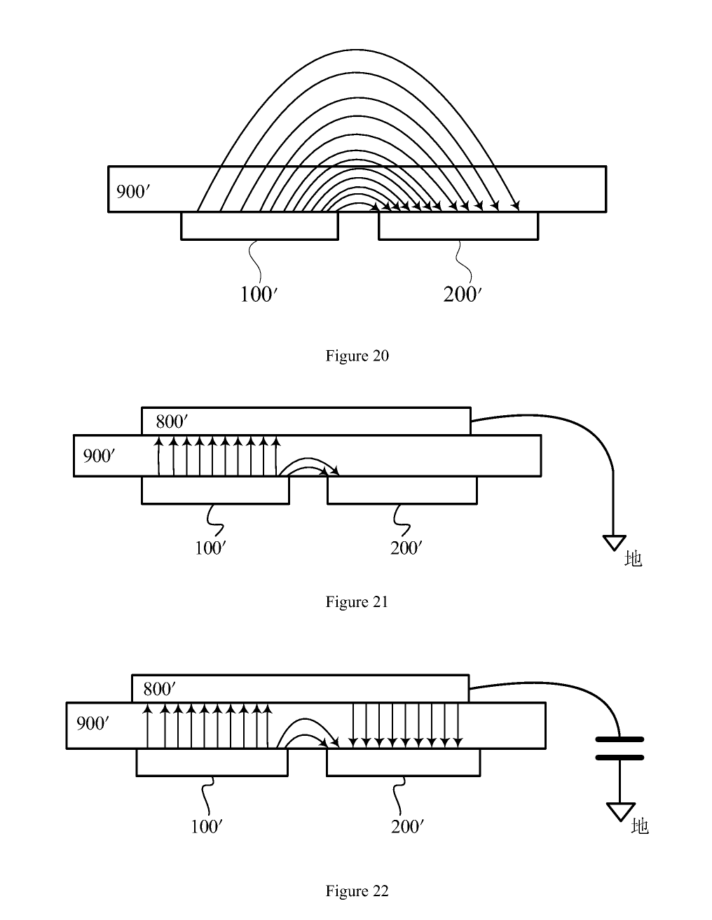

Theoretically, the electrode is made into a mesh structure is mainly favorable for increasing the short-range coupling effect between electrodes and reducing long-range coupling, changing the electric field distribution between electrodes, and enhancing electric field intensity. Meanwhile, because the dispersedly distributed mesh electrode structure is used, the distribution of electric field lines between the two electrodes becomes more uniform, and their coupling becomes more sufficient. The first embodiment of the present invention, as shown in FIG. 5 to FIG. 7, respectively shows the schematic diagram of the electric field distribution when the touch screen with electrode protecting film 900 is not touched, is touched, and is touched in the suspended state. The above figures show that the electric field distribution effect is in accordance with the conclusion of the above theoretical analysis obviously. The schematic diagram of the electric field distribution is also a result obtained by experimental verification. As shown in FIG. 20 to FIG. 22, compared with the touch screen of the prior art, the present invention has the advantages that more short-range capacitance is reduced while less long-range capacitance is increased when the electric field lines of the dispersedly distributed electrode structure are distributed in the suspended state, so that the change rate of the touch capacitance is still larger and the touch action still can be identified when the touch screen of the present invention is in the suspended state. As shown in FIG. 22, when the ordinary capacitance screen is touched in the suspended state, the distance of the long-range power lines is shortened to the sensing electrodes from the driving electrodes through the human body or the special-purpose touch device, which is in equivalent to shortening the distance between two coupling electrodes. Thus, the coupling capacitance between two electrodes is increased; while the distance of the short-range power lines is increased, which is in equivalent to increasing the distance between the two coupling electrodes. Thus, the coupling capacitance between two electrodes is reduced. Under equal conditions, the capacitance coupling of the dispersedly distributed capacitance touch screen of the present invention is mainly formed by short-range coupling, in the suspended state, although major part of the coupling power lines return to the sensing electrodes from the driving electrodes, the capacitance reduced amplitude caused by the addition of the short-range coupling power lines is far more than the amplitude of the capacitance addition caused by the reduction of the long-range coupling power lines under the condition that the short-range coupling is major. Therefore, the total capacitance is obviously reduced. In contrast, the change rate of the touch capacitance between the first electrodes and the second electrodes when the touch screen is touched in the suspended state can be guaranteed preferably. Experiments prove that the mesh electrode structure of the present invention is favorable for improving the touch sensing effect of the screen body in the suspended state.

When there is water on the body of the touch screen of the present invention, the water is similar to a suspended conductor at this moment. As mentioned above, the coupling capacitance between two electrodes of the touch screen of the prior art will be obviously increased through water, so that the capacitance change rate caused by the touch of the human body or the special-purpose touch device 800 will be reduced. The dispersedly distributed mesh electrode touch screen of the present invention can effectively use the coupling area between the first electrodes 110 and the second electrodes 210, when water exists, the increment of the coupling capacitance between the first electrodes 110 and the second electrodes 210 is relatively less, so that the capacitance change rate is larger than that of the touch screen of the prior art when the touch screen is touched by the human body or the special-purpose touch device 800. Therefore, the dispersedly distributed mesh electrode touch screen of the present invention has preferable waterproof performance.

Meanwhile, because the touch screen of the present invention uses mesh distribution structure, when Electrostatic Discharge (ESD) exists, the mesh distribution structure can effectively release static electricity through the mesh connection structure in real time, so that the capacity of the screen body resistant to the ESD can be effectively increased.

Experiments prove that the waterproof performance and suspended performance of the mesh distributed screen body are obviously better than those of the centrally distributed screen body, and the performance can be increased by 20% at least in general.

Various specific structures of the first electrodes 110 and the second electrodes 210 will be specifically described through three embodiments as follows:

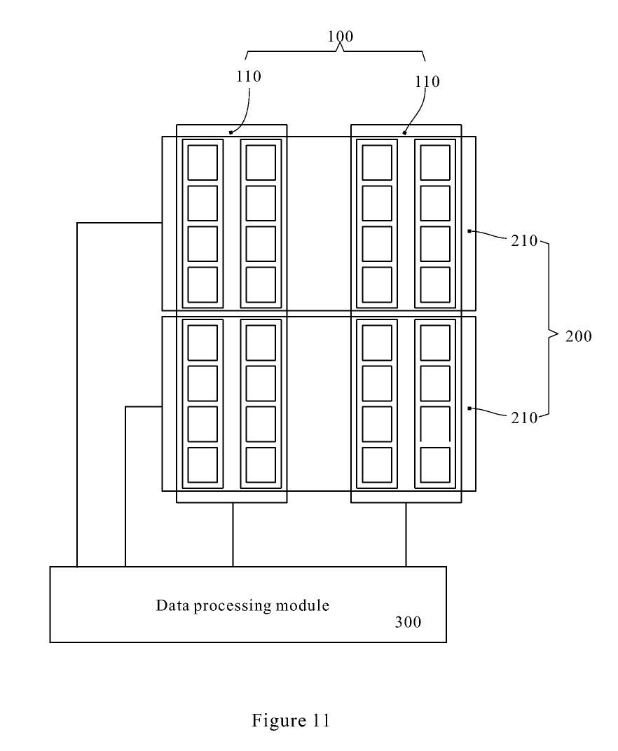

In the third embodiment of the present invention, as shown in FIG. 11 to FIG. 13, each first electrode 110 uses the mesh structure, while the second electrodes 210 uses a plate electrode. Namely if it is expected to achieve the effect of dispersedly distributing capacitance, it is not required that both the first electrodes 110 and the second electrodes 210 are in the mesh structure, the effect of dispersedly distributing capacitance can be achieved so long as only one of them is in the mesh structure. More specifically, the first electrodes 110 are formed by rectangle meshes 112, the meshes 112 can be regarded to be formed by multiple rectangle sub-electrode plates 111 around the meshes 112. Therefore, the first electrodes 110 of the third embodiment of the present invention belong to the mesh electrodes formed by the sub-electrode plates 111 in a single shape, and the shape of the sub-electrode plates 111 can be different polygon, rotundity and ellipse.

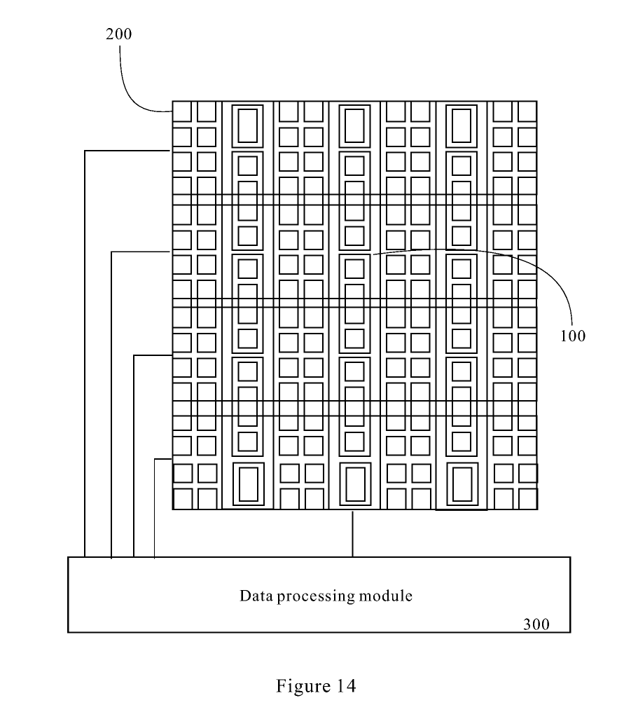

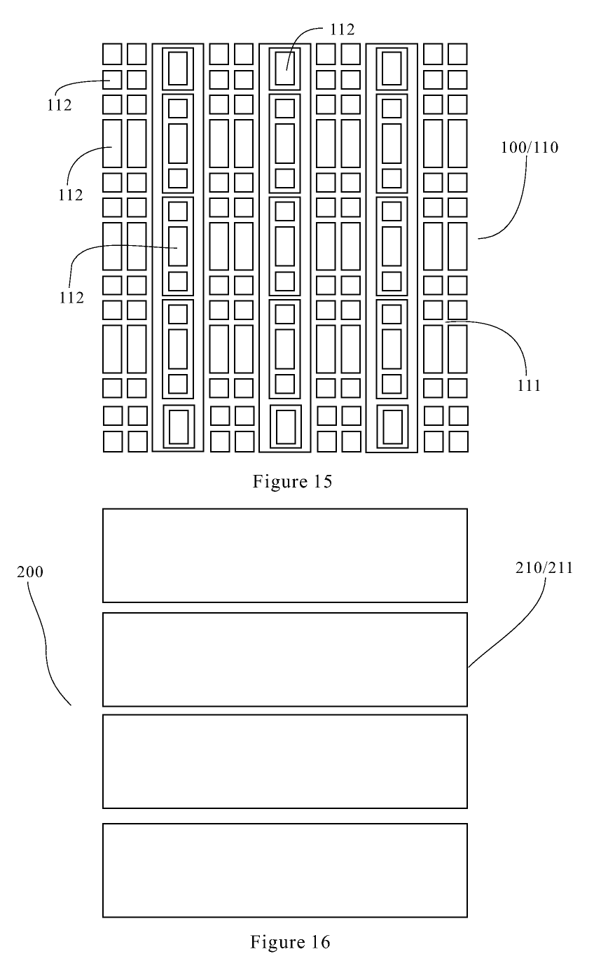

In the fourth embodiment of the present invention, as shown in FIG. 14 to FIG. 16, each first electrode 110 uses the mesh structure, while the second electrode 210 uses the plate electrode. The first electrodes 110 use different types of meshes to further increase the effect of dispersedly distributing capacitance.

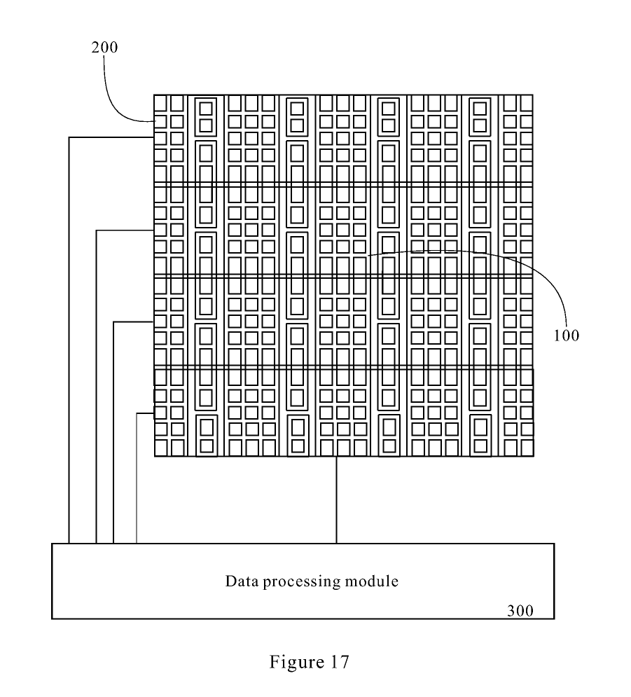

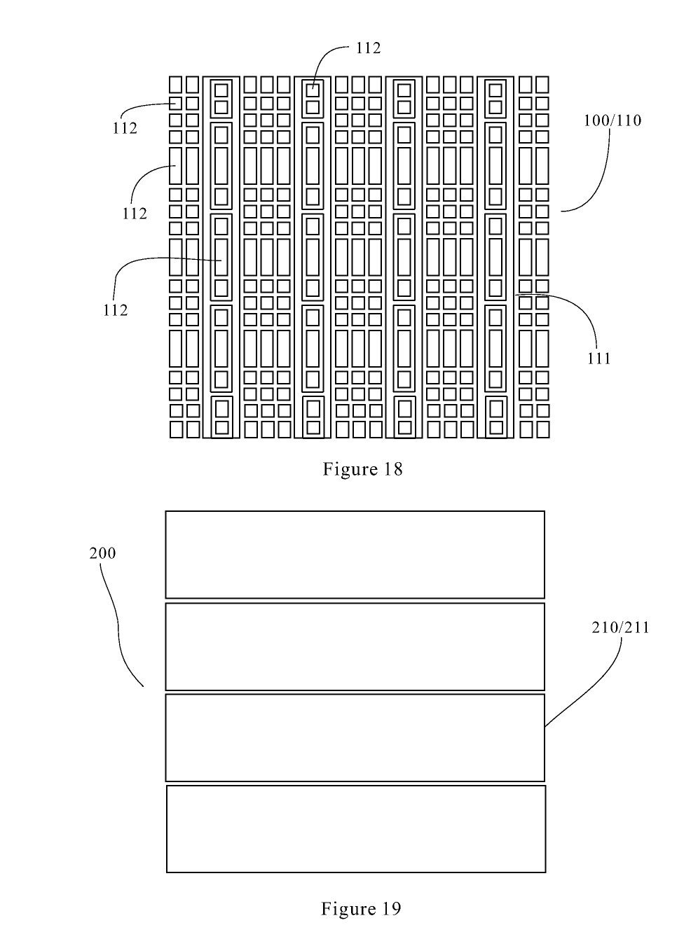

In the fifth embodiment of the present invention, as shown in FIG. 17 to FIG. 19, the first electrode 110 uses the mesh structure, while the second electrode 210 uses the plate electrode. The first electrode 110 also uses different types of meshes, only the specific shape and the arrangement rule of the meshes are different from those of the fourth embodiment, and the final aim of the fifth embodiment is also to further increase the effect of dispersedly distributing capacitance.

In the second embodiment of the present invention, as shown in FIGS. 8 to 10, the first electrode group 100 includes three first electrodes 110 which longitudinally extend, and the second electrode group 200 includes two second electrodes 210 which laterally extend. Both the first electrodes 110 and the second electrodes 210 are of the mesh structure. Each first electrode 110 is formed by rhombic sub-electrode plates 111 in two columns, and all the sub-electrode plates 111 form the rhombic meshes 112 in the column in the middle part after they form the mesh structure. Each second electrode 210 is formed by rhombic sub-electrode plates 211 in two rows in the same way, and all the sub-electrode plates 211 form the rhombic meshes 212 in the row in the middle part after they form the mesh structure. Therefore, the first electrodes 110 and the second electrodes 210 of the second embodiment of the present invention respectively belong to mesh electrodes formed by the sub-electrode plates 111 and 211 which are in a single shape, and the shape of the sub-electrode plates 111 and 211 can be different polygon, rotundity and ellipse.

In the first embodiment of the present invention, as shown in FIGS. 1 to 3, the first electrode group 100 includes three first electrodes 110 which longitudinally extend, and the second electrode group 200 includes three second electrodes 210 which laterally extend. Both the first electrodes 110 and the second electrodes 210 are of the mesh structure. Each first electrode 110 is formed by rhombic sub-electrode plates 111 in two columns, and all the sub-electrode plates 111 form the rhombic meshes 112 in the column in the middle part after they form the mesh structure. Each second electrode 210 is formed by rhombic and hexagonal sub-electrode plates 211 which are alternately arranged in two rows, and all the sub-electrode plates 211 form the rhombic meshes 212 in the row in the middle part after they form the mesh structure. In the first embodiment of the present invention, all the sub-electrode plates 111 and 211 are shown by the thalweg made of transparent material to distinguish the sub-electrode plates 111 and 211 from the meshes 112 and 212. The first electrodes 110 of the first embodiment of the present invention belong to the mesh electrodes formed by the sub-electrode plates 111 in a single shape, and the second electrodes 210 belong to the mesh electrodes formed by the sub-electrode plates 211 in different shapes. The shape of the sub-electrode plates 111 can be polygon, rotundity or ellipse. The shape of the sub-electrode plates 211 can be the combination of any two of different polygon, rotundity or ellipse. Obviously, the shape of the sub-electrode plates 211 can be the combination of any various shapes of different polygon, rotundity or ellipse.

The different polygon of the present invention includes quadrangle, regular quadrangle, pentagon, regular pentagon, hexagon, regular hexagon, octagon and regular octagon.

In order to increase the effective capacitivity of the touch screen, on the whole touch screen, the positions of the meshes 112 of the first electrodes 110 are corresponding to the positions of the sub-electrode plates 211 of the second electrodes 210, and the positions of the sub-electrode plates 111 of the first electrodes 110 are corresponding to the positions of the meshes 212 of the second electrodes 210, namely the positions of the meshes 112 and the sub-electrode plates 111 of the first electrodes 110 are respectively complementary to the positions of the sub-electrode plates 211 and the meshes 212 of the second electrodes 210. The structure makes that there is no opposite electrode plates between the first electrodes 110 and the second electrodes 210 so that the variable electric field intensity between the first electrodes 110 and the second electrodes 210 is increased, namely the capacitance change is increased so that the effective capacitivity of the touch screen is increased. As a preferred plan, three embodiments of the present invention use the above complementary structure.

The first electrodes 110 of the present invention are distinguished from the second electrodes 210 only in structure, namely one can be used for lateral arrangement, and the other can be used for longitudinal arrangement. Thus, the two electrodes can accord with the orthogonality relation. The first electrodes 110 are not distinguished from the second electrodes 210 at the angle of the implementation function. Therefore, if the touch screen is a mutual-capacitance touch screen, the electrode receiving excitation signals from the data processing module 300 in the first electrodes 110 and the second electrodes 210 is a driving electrode, and the electrode used for feeding back electrical signals to the data processing module 300 to detect the capacitance change is a sensing electrode.

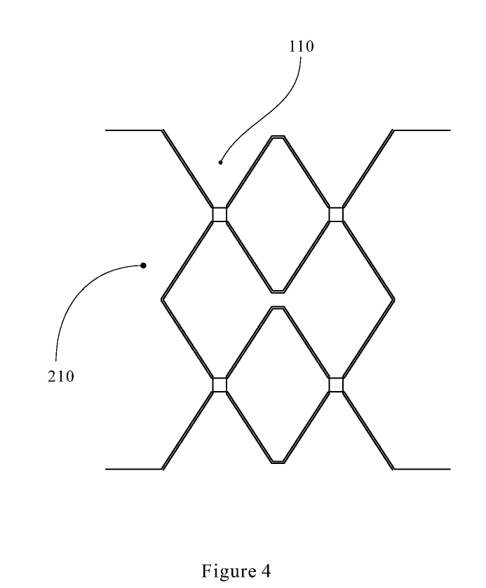

The touch screen of the present invention can use the layered structure, and the first electrodes 110 and the second electrodes 210 are respectively arranged in two mutually parallel planes between which a clearance exists. The touch screen of the present invention can also use the monolayer structure, and the first electrodes 110 and the second electrodes 210 are arranged in the same plane. When the monolayer structure is used, it is to be noted that the first electrodes 110 and the second electrodes 210 shall be orthogonally arranged in a mutual non-contact mode, namely the cross section of the first electrodes 110 and the second electrodes 210 can not be in point contact by the bridge cross-over technology of the conductive material. The first embodiment of the present invention uses a monolayer structure. FIG. 4 shows a capacitor cell formed by orthogonally arranging the first electrodes 110 and the second electrodes 210. Therefore, the bridge technology shall be used in the intersection part of the first electrodes 110 and the second electrodes 210.

In addition, in order to further enhance the degree of coupling between the first electrodes 110 and the second electrodes 210 so as to increase the effective capacitivity, the touch screen of the present invention also includes dummy electrodes which are made of transparent conductive material and are in the electrical suspended state. The dummy electrodes are not electrically connected and the dummy electrodes are not electrically connected with other modules of the touch screen, namely the dummy electrodes are in the electrical suspended state. The dummy electrodes achieve the electric field relay function between the first electrodes 110 and the second electrodes 210, as to increase the variable electric field intensity between the first electrodes 110 and the second electrodes 210. The dummy electrodes and the first electrodes 110 or the second electrodes 210 are arranged in the same plane, or the dummy electrodes are arranged parallel to the first electrodes 110 or the second electrodes 210.

The touch screen of the present invention also includes a guard electrode made of transparent conductive material. The guard electrode is electrically connected with the DC power source or is directly connected with the ground. The guard electrode can reduce the eigen field intensity between the first electrodes 110 and the second electrodes 210, so that the variable electric field intensity between them can be increased to increase the effective capacitivity of the touch screen. The eigen field intensity refers to the electric field intensity which is formed between the two electrodes and is difficulty affected by the outside electrodes. The guard electrode and the first electrodes 110 or the second electrodes 210 are arranged in the same plane, or the guard electrode is arranged parallel to the first electrodes 110 or the second electrodes 210.

1. A capacitance touch screen with mesh electrodes includes a first electrode group and a second electrode group made of transparent conductive material, and a data processing module, wherein the first electrode group includes mutually parallel first electrodes, and the second electrode group includes mutually parallel second electrodes; any first electrode and any second electrode are orthogonally arranged in a mutual non-contact mode; and the data processing module is used for sending excitation signals, detecting capacitance change and determining touch position coordinates in accordance with the detecting condition of the capacitance, and both the first electrode group and the second electrode group are electrically connected with the data processing module;
The capacitance touch screen is characterized in that at least either the first electrode or the second electrode includes at least two sub-electrode plates, all the sub-electrode plates in the electrodes which are the same are arranged in accordance with a mesh structure, namely at least either the first electrode or the second electrode is processed with a mesh, each mesh are surrounded by respective sub-electrode plates around the meshes.

2. The capacitance touch screen with mesh electrodes as claimed in claim 1, characterized in that the shape of the sub-electrode plates includes at least one of different polygon, rotundity and ellipse.

3. The capacitance touch screen with mesh electrodes as claimed in claim 2, characterized in that the polygon includes quadrangle, regular quadrangle, pentagon, regular pentagon, hexagon, regular hexagon, octagon and regular octagon.

4. The capacitance touch screen with mesh electrodes as claimed in claim 1, characterized in that on the whole touch screen, the positions of the meshes of the first electrodes are corresponding to the positions of the sub-electrode plates of the second electrodes, the positions of the sub-electrode plates of the first electrodes are corresponding to the positions of the meshes of the second electrodes, namely the positions of the meshes and the sub-electrode plates of the first electrodes are respectively complementary to the positions of the sub-electrode plates and the meshes of the second electrodes.

5. The capacitance touch screen with mesh electrodes as claimed in claim 1, characterized in that the touch screen is a mutual-capacitance touch screen, the electrode receiving excitation signals from the data processing module in the first electrodes and the second electrodes is a driving electrode, and the electrode used for feeding back electrical signals to the data processing module to detect the capacitance change is a sensing electrode.

6. The capacitance touch screen with mesh electrodes as claimed in claim 1, characterized in that the first electrodes and the second electrodes are respectively arranged in two mutually parallel planes between which a clearance exists.

7. The capacitance touch screen with mesh electrodes as claimed in claim 1, characterized in that the first electrodes and the second electrodes are arranged in the same plane.

8. The capacitance touch screen with mesh electrodes as claimed in claim 1, characterized in that the touch screen also includes dummy electrodes which are made of transparent conductive material and are in the suspending state;
the dummy electrodes are not electrically connected and the dummy electrodes are not electrically connected with other modules of the touch screen;
and the dummy electrodes and the first electrodes or the second electrodes are arranged in the same plane, or the dummy electrodes are arranged parallel to the first electrodes or the second electrodes.

9. The capacitance touch screen with mesh electrodes as claimed in claim 1, characterized in that the touch screen also includes a guard electrode made of transparent conductive material;
the guard electrode is electrically connected with the DC power source or is directly connected with the ground;
and the guard electrode and the first electrodes or the second electrodes are arranged in the same plane, or the guard electrode is arranged parallel to the first electrodes or the second electrodes.

10. The capacitance touch screen with mesh electrodes as claimed in claim 1, characterized in that the transparent conductive material includes Indium Tin Oxide i.e. ITO and Antimony Tin Oxide i.e. ATO.

11. The capacitance touch screen with mesh electrodes as claimed in claim 8, characterized in that the transparent conductive material includes Indium Tin Oxide i.e. ITO and Antimony Tin Oxide i.e. ATO.

12. The capacitance touch screen with mesh electrodes as claimed in claim 9, characterized in that the transparent conductive material includes Indium Tin Oxide i.e. ITO and Antimony Tin Oxide i.e. ATO.
